(19) United States
(12) Patent Application Publication
(10) Pub. No.: US 2025/0381706 A1
(43) Pub. Date: Dec. 18, 2025

(54) PART FABRICATION UTILIZING IN-SITU REACTION FORMATION OF FIBER-REINFORCED CERAMIC

(71) Applicant: Raytheon Company, Arlington, VA (US)

(72) Inventors: Tommy Skiba, East Hartford, CT (US); Prabhjot Singh, West Hartford, CT (US); Gajawalli V. Srinivasan, South Windsor, CT (US); Venkata R. Vedula, Unionville, CT (US); Juan de Bedout, Sudbury, MA (US); Vijay V. Pujar, San Diego, CA (US); Sarah Boardman, Vernon, CT (US)

(21) Appl. No.: 19/240,536

(22) Filed: Jun. 17, 2025

Related U.S. Application Data
(60) Provisional application No. 63/660,948, filed on Jun. 17, 2024.

(51) Int. Cl. B28B 1/00; B33Y 10/00; B33Y 40/10; B33Y 80/00; C04B 41/00

(52) U.S. Cl. CPC B28B 1/001; B33Y 10/00; B33Y 40/10; B33Y 80/00; C04B 41/0072; C04B 2235/5244; C04B 2235/5248; C04B 2235/614

(57) ABSTRACT

A method of additively manufacturing a part by printing the part, layer-by-layer, on a substrate, such that the part is formed of a plurality of layers, each of the layers is built up by simultaneously: (i) directing a fiber feedstock stream, of fiber feedstock, toward a point of deposition on the substrate or a previously deposited layer; (ii) directing one or more precursor streams, of one or more precursors, toward the point of deposition on or near the fiber feedstock stream; and (iii) directing one or more energy sources toward the point of deposition; the one or more precursors reacts to form a ceramic that is deposited on and around the fiber feedstock, thereby forming a ceramic matrix composite that includes the ceramic formed from the one or more precursor streams embedded with fiber from the fiber feedstock; and repeating steps (i) to (iii) until printing the layers is complete.

### CROSS-REFERENCE TO RELATED APPLICATIONS

This application claims the benefit of priority to U.S. Application No. 63/660,948 filed Jun. 17, 2024, the disclosure of which is incorporated herein by reference in its entirety.

### BACKGROUND

The embodiments are directed to part fabrication for aircrafts and more specifically to part fabrication utilizing in-situ reaction formation of fiber-reinforced ceramic.

When manufacturing a part, e.g., for an aircraft, advanced composites may be utilized. The process may utilize continuous or discontinuous (e.g., long or chopped) fibers in the form of a weave or a sheet of fabric, cloth or tape, which is then utilized in conjunction with a mold and tooling to form a shape of the desired part. The process may be performed manually or automated, e.g., utilizing an AFP (automated fiber placement) process. Parts made from these manually or automated placement processes may have limits to the type of geometries that can be built. The shaped parts are then subject to one or more of polymer curing, polymer impregnation, pyrolysis, chemical vapor infiltration and reaction to produce a densified part with low porosity. One or more of the above-mentioned processes may be repeated several times to produce parts with acceptable levels of density and porosity to achieve properties and performance requirements for the intended application. Further, the fabrication of parts can take weeks or months.

### BRIEF SUMMARY

Disclosed is a method of additively manufacturing a part, including printing the part, layer-by-layer, on a substrate, such that the part is formed of a plurality of layers, wherein each of the layers is built up by simultaneously: (i) directing a fiber feedstock stream, of fiber feedstock, toward a point of deposition on the substrate or a previously deposited layer; (ii) directing one or more precursor streams, of one or more precursors, toward the point of deposition on or near the fiber feedstock stream; and (iii) directing one or more energy sources toward the point of deposition, whereby the one or more precursors reacts to form a ceramic that is deposited on and around the fiber feedstock, thereby forming a ceramic matrix composite that includes the ceramic formed from the one or more precursor streams embedded with fiber from the fiber feedstock; and repeating steps (i) to (iii) until printing the layers is complete.

In addition to one or more aspects of the method, or as an alternative the one or more precursor streams includes a plurality of precursor streams, wherein the plurality of precursor streams are formed of mutually unique materials configured to react with one another to thereby form the ceramic.

In addition to one or more aspects of the method, or as an alternative the plurality of precursor streams includes a first precursor stream and a second precursor stream, wherein the first precursor stream includes particles, and the method includes: selecting the second precursor stream to form a precursor coating or engage the particles in the first precursor stream, and applying the one or more energy sources at the point of deposition to cause one or more of the plurality of precursor streams to react or engage with the particles to form the ceramic.

In addition to one or more aspects of the method, or as an alternative the one or more precursors includes a plurality of precursors, wherein one of the plurality of precursors includes one or more of silicon; hafnium; zirconium; titanium; tantalum; tungsten; niobium; molybdenum; or rhenium; and another one of the plurality of precursors includes one or more of boron, carbon, oxygen, or nitrogen; or a combination of any one of the plurality of precursors, within and between layers.

In addition to one or more aspects of the method, or as an alternative, the method includes selecting at least one of the one or more precursor streams and the one or more energy sources and directing the at least one of the one or more precursor streams and the one or more energy sources to the point of deposition on the fiber feedstock to react and form an interface layer; and selecting another one of the one or more precursor streams and another one of the one or more energy sources, and directing the another one of the one or more precursor streams and the another one of the one or more energy sources to the point of deposition on the interface layer, whereby the one or more precursors react to form the ceramic on the interface layer; thereby forming the ceramic matrix composite including the fiber feedstock, the ceramic, and the interface layer between the fiber and the ceramic.

In addition to one or more aspects of the method, or as an alternative the fiber includes one or more of a ceramic fiber, a carbon fiber or silicon carbide fiber; and the ceramic includes of one or more of a carbon, boron carbide, boron nitride, silicon carbide, silicon nitride, hafnium carbide, or zirconium carbide.

In addition to one or more aspects of the method, or as an alternative the interface layer includes one or more of a carbon, or boron nitride.

In addition to one or more aspects of the method, or as an alternative, the method includes printing the part as graded structure by varying, while printing, a relative amount of one or more of silicon, hafnium, zirconium, titanium, tantalum, tungsten, niobium, molybdenum, rhenium, boron, carbon, nitrogen, or oxygen.

In addition to one or more aspects of the method, or as an alternative, the method includes heating the one or more precursor streams with the one or more energy sources to liquify or vaporize the one or more precursors or the precursor coating while forming the ceramic; or so that the one or more precursor streams, or the precursor coating, to remain as solid particulates and form the ceramic.

In addition to one or more aspects of the method, or as an alternative, the method includes directing the one or more energy sources to the substrate through at least one of the one or more precursor streams or the fiber feedstock.

In addition to one or more aspects of the method, or as an alternative, the method includes printing each one of the layers to includes lines, wherein: the lines on a layer are oriented parallel to each other; and the lines along successive ones of the layers are disposed at an angle to each other.

In addition to one or more aspects of the method, or as an alternative, the method includes, after printing the part, one or more of: applying chemical vapor infiltration (CVI) to the part to decrease porosity of the part; or heating the part to further complete conversion of precursors to product or densify the part by sintering.

Further disclosed is a system for additively manufacturing a part, including a chamber that is filled with an inert gas; a substrate in the chamber; a robotic arm in the chamber, wherein the robotic arm has one or more nozzles, and wherein the robotic arm is configured to produce an energy source; one or more precursor storage units from which the one or more nozzles obtains one or more precursors; and one or more feedstock storage units from which the one or more nozzles obtains fiber feedstock; wherein the robotic arm is configured to print the part, layer-by-layer, on the substrate, such that the part is formed of a plurality of layers, and wherein, within each one of the plurality of layers, the robotic arm is configured to, simultaneously: (i) direct a fiber feedstock stream, of the fiber feedstock, toward a point of deposition on the substrate or a previously deposited layer; (ii) direct one or more precursor streams toward the point of deposition on or near the fiber feedstock stream, and at least one of the one or more precursor streams includes a first precursor; and (iii) direct one or more energy sources toward the point of deposition, whereby the one or more precursors reacts to form a ceramic that is deposited on and around the fiber feedstock, thereby forming a ceramic matrix composite that includes the ceramic formed from the one or more precursor streams embedded with fiber from the fiber feedstock; and repeating steps (i) to (iii) until printing the layers is complete.

In addition to one or more aspects of the system, or as an alternative, the one or more precursor streams includes a plurality of precursor streams, wherein the plurality of precursor streams are formed of mutually unique materials configured to react with one another to thereby form the ceramic.

In addition to one or more aspects of the system, or as an alternative, at least one of the one or more precursor streams, and the one or more energy sources, are configured for being selected, and the at least one of the one or more precursor streams and the one or more energy sources are configured for being directed to the point of deposition on the fiber feedstock to react and form an interface layer; another one of the one or more precursor streams and another one of the one or more energy sources are configured for being selected, and directing the another one of the one or more precursor streams and the another one of the one or more energy sources are configured for directed to the point of deposition on the interface layer, whereby the one or more precursors react to form the ceramic on the interface layer; whereby the ceramic matrix composite is formed, including the fiber feedstock, the ceramic, and the interface layer between the fiber and the ceramic.

In addition to one or more aspects of the system, or as an alternative, the one or more precursor streams is configured for being selected and the one or more energy sources is configured for being applied so that one of the one or more precursor streams is configured to form a precursor coating; and the one or more precursor streams is configured for being heated with the one or more energy sources: to liquify or vaporize the one or more precursors or the precursor coating while forming the ceramic; or so that the one or more precursor streams, or the precursor coating, remain solid particulates and form the ceramic.

Further disclosed is an additively manufactured part, produced by a method including printing the part, layer-by-layer, on a substrate, such that the part is formed of a plurality of layers, wherein, each one of the layers is printed by simultaneously: (i) directing a fiber feedstock stream, of fiber feedstock, toward a point of deposition on the substrate or a previously deposited layer; (ii) directing one or more precursor streams, of one or more precursors, toward the point of deposition on or near the fiber feedstock stream; and (iii) directing one or more energy sources toward the point of deposition, whereby the one or more precursors reacts to form a ceramic that is deposited on and around the fiber feedstock, thereby forming a ceramic matrix composite that includes the ceramic formed from the one or more precursor streams embedded with fiber from the fiber feedstock; and repeating steps (i) to (iii) until printing the one of the layers is complete.

In addition to one or more aspects of the part, or as an alternative, the one or more precursor streams includes a plurality of precursor streams, wherein the plurality of precursor streams is formed of mutually unique materials configured to react with one another to thereby form the ceramic.

In addition to one or more aspects of the part, or as an alternative, the method further includes: selecting at least one of the one or more precursor streams and the one or more energy sources and directing the at least one of the one or more precursor streams and the one or more energy sources to the point of deposition on the fiber feedstock to react and form an interface layer; selecting another one of the one or more precursor streams and another one of the one or more energy sources, and directing the another one of the one or more precursor streams and the another one of the one or more energy sources to the point of deposition on the interface layer, whereby the one or more precursors react to form the ceramic on the interface layer; thereby forming the ceramic matrix composite including the fiber feedstock, the ceramic, and the interface layer between the fiber and the ceramic.

In addition to one or more aspects of the part, or as an alternative, the method further includes: heating the one or more precursor streams with the one or more energy sources: to liquify or vaporize the one or more precursors, or a precursor coating, while forming the ceramic; or so that the one or more precursor streams, or the precursor coating, remain solid particulates and form the ceramic.

### BRIEF DESCRIPTION OF THE DRAWINGS

The present disclosure is illustrated by way of example and not limited in the accompanying figures in which like reference numerals indicate similar elements.

FIG. 1A shows an aircraft having components that may be manufactured in accordance with the disclosed method and apparatus;

FIG. 1B shows a part that is additively manufactured according to an embodiment;

FIG. 2 shows a robot in a chamber with a substrate that is used to manufacture the part, according to an embodiment;

FIG. 3 shows details of nozzles integrated into an end effector of the robot, according to an embodiment;

FIG. 4 shows details of precursor streams, fiber streams, and an energy source, directed to the substrate when manufacturing the part, according to an embodiment;

FIG. 5A shows the nozzles printing the part, having completed portions of at least two layers, according to an embodiment;

FIG. 5B is a schematic illustration of an interface layer between fiber feedstock and a surrounding ceramic;

FIG. 6 is a flowchart showing a method of manufacturing the part, line-by-line, and layer-by-layer, on the substrate utilizing the system, according to an embodiment;

FIG. 7 is a flowchart showing additional details of deposition of the precursor stream on the substrate when forming the part; and

FIGS. 8A and 8B provide another flowchart showing the method of additively manufacturing the part according to other aspects of the embodiments.

### DETAILED DESCRIPTION

Aspects of the disclosed embodiments will now be addressed with reference to the figures. Aspects in any one figure is equally applicable to any other figure unless otherwise indicated. Aspects illustrated in the figures are for purposes of supporting the disclosure and are not in any way intended on limiting the scope of the disclosed embodiments. Any sequence of numbering in the figures is for reference purposes only.

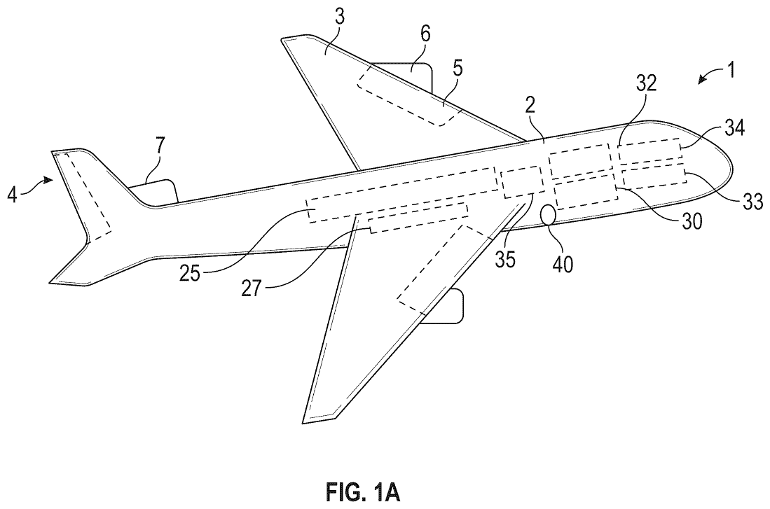

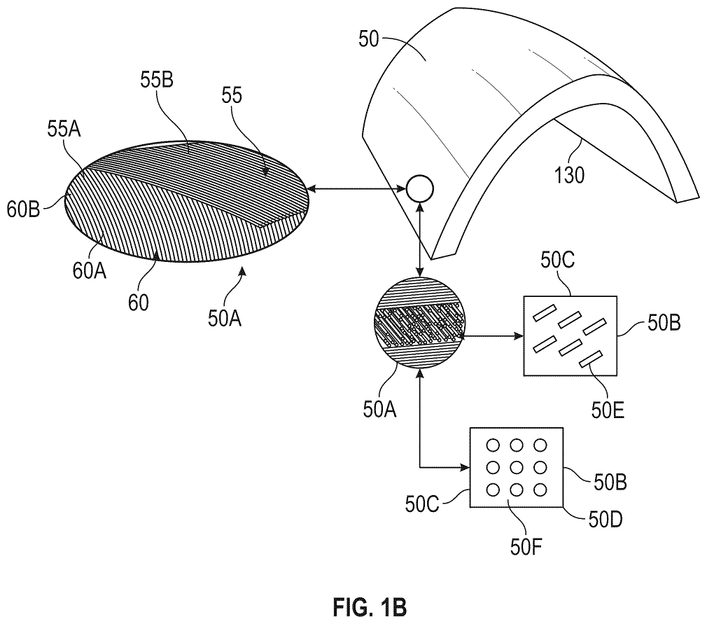

FIG. 1A shows an aircraft 1 having a fuselage 2 with a wing 3 and tail assembly 4, which may have control surfaces 5. The wing 3 may include an engine 6, such as a gas turbine engine, and an auxiliary power unit (APU) 7 may be disposed at the tail assembly 4. The aircraft 1 may have a cabin 25, a cargo bay 27, an environmental control system (ECS) 30 for conditioning the cabin 25 and/or cargo bay 27. The ECS 30 may include a vapor compression system (VCS) 32 that cools air directed to, e.g., the cargo bay 27 and provides refrigeration to one or more systems 35 of the aircraft 1, and an air cycle machine (ACM) that cools air directed to e.g., the cabin 25. A RAM air inlet 40 may scoop air for the ECS 30, or the ECS 30 may receive air recirculated from, e.g., a cabin air compressor (CAC) 34.

Turning now to FIG. 1B, a part 50 of the aircraft is additively manufactured according to a process disclosed herein. As manufactured, rather than being a monolith structure, the part may be a ceramic matrix composite (CMC) 50A with a base 50B formed of a ceramic 50C and continuous fibers 50D or discontinuous (long or chopped) fibers 50E (generally fibers 50F) embedded in the base 50B. The fibers 50F maybe ceramics and more specifically may be carbon fiber or silicon carbide fiber.

As will be discussed in greater detail below, the part 50 may be manufactured, line-by-line and layer-by-layer so that the part 50 has a plurality of layers 55A, 55B (generally referred to as 55), each with a plurality of adjacent lines 60A, 60B (generally referred to as 60). The lines 60 in adjacent layers 55 may be at an acute angle to each other, such as forty-five degrees, or they may be parallel, depending on the desired configuration. As discussed in greater details below, the lines 60 and layers 55 may have a constant material property or the material properties may change as desired so that the part 50 is configured as a graded structure (defined below). Such change in characteristics may include material strength, melting temperature, oxidation resistance or other such changes as deemed necessary.

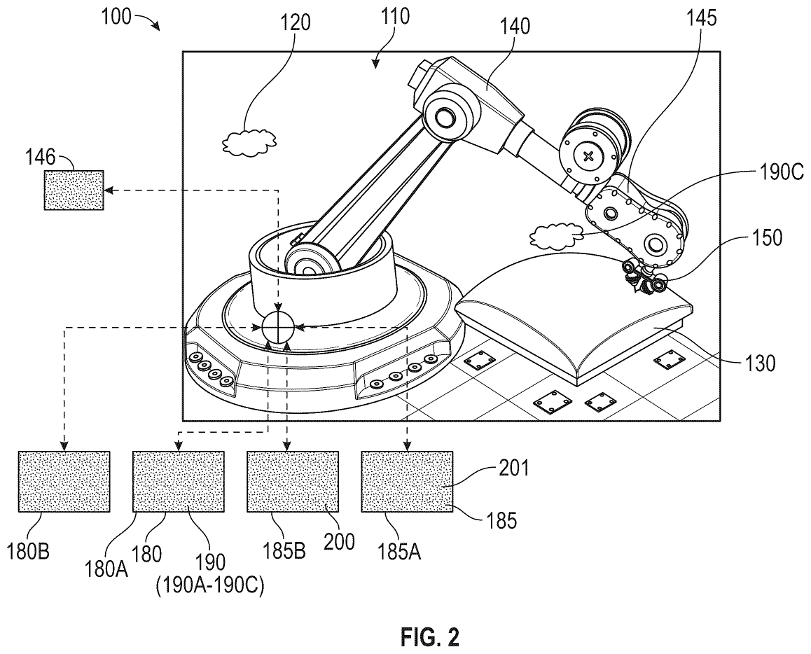

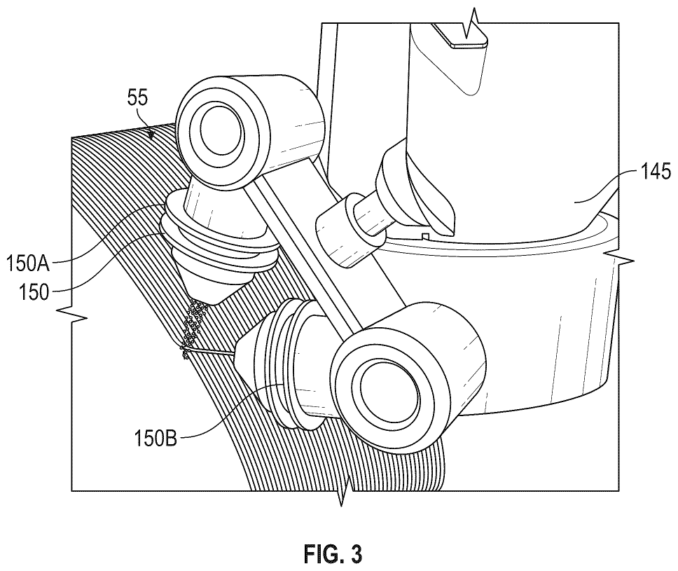

As shown in FIGS. 2-5 the part 50 may be printed by a system 100 for additively manufacturing the part 50. The system 100 may include a chamber 110 that is filled with an inert gas 120. A substrate 130 may be in the chamber 110. The substrate 130 may be a prebuilt part onto which a feature formed by the process disclosed herein is added, such as a boss or flange. That is, though the part 50 is shown is being printed over an entire surface of the substrate 130, that is not intended on limiting the scope of the application of the embodiments.

A robot (robotic arm) 140 may be in the chamber 110. The robot 140, at its end effector 145, may have one or more nozzles including, in a nonlimiting example, a first nozzle 150A and a second nozzle 150B (generally referenced as 150). The nozzles 150 may be concentric or separate and directed to a common point (as shown) as nonlimiting examples. In addition, the end effector 145 may be configured to produce an energy source 170 (or a plurality of energy sources), e.g., a focused and/or directed stream of energy, which may also be considered an energy beam, which may be a laser, an electric arc, including but not limited to a plasma arc, or an electron beam. The energy source 170 may also be provided by a separate implement. The system 100 may have one or more precursor storage units 180, i.e., a first precursor storge unit 180A from which the first nozzle 150A obtains a first precursor 190A. The system 100 may have one or more feedstock storage units 185, i.e., a feedstock storage unit 185B, from which the second nozzle 150B obtains a first fiber feedstock 200 and as programed a second fiber feedstock 201, generally referenced as fiber feedstock 200.

As discussed in greater detail below, in one embodiment the first precursor 190A includes a first material and the first precursor 190A may have an outer coating made of a second material, i.e., a second precursor 190B, which may be for example be a precursor coating 190B. For simplicity the different precursors herein shall be referred to as precursors 190. It is to be appreciated that the precursor coating may be any one of the precursors 190, and is not limited to the second precursor 190B. One of the precursors 190 may include one or more of silicon, hafnium, zirconium, titanium, tantalum, tungsten, niobium, molybdenum, or rhenium, and the outer element may be carbon. Another of the first and second precursors 190 may include one or more of boron, carbon, oxygen, or nitrogen. Within the scope of the disclosure is a combination of any one of the identified options for the first and second precursors 190, within and between layers 55. As a result, the ceramic 50C may be any one or more of boron carbide (B₄C), boron nitride (BN), molybdenum disilicide (MoSi₂), a mixture of silicon nitride and silicon carbide (SiN+SiC, or Si—N—C); SiC; hafnium carbide (HfC), and zirconium carbide and hafnium carbide mixture (ZrC and HfC, or Zr—Hf—C).

In one embodiment the first precursor 190A may not have a coating and may engage a third precursor 190C, which can be for example a precursor gas 190C, made of a third material at the location of deposition on the substrate. It is to be appreciated that the precursor gas may be any one of the precursors 190, and is not limited to the third precursor 190C. For example, the first precursor 190A may be made of include one or more of silicon, hafnium, zirconium, titanium, tantalum, tungsten, niobium, molybdenum, or rhenium, and the precursor in the form of a gas 190C (alternatively referred to as a precursor gas) may be made of one or more of boron, carbon, oxygen, or nitrogen. may be included that has carbon, such as methane.

In one embodiment, where the precursor gas 190C is utilized, the precursor gas 190C includes carbon and more specifically the precursor gas is a hydrocarbon. The hydrocarbon selected from methane, ethane, propane, butane, benzene, naphthalene, or a combination. In one embodiment the precursor gas 190C is natural gas. In one embodiment, where the precursor gas 190C is utilized, the precursor gas includes nitrogen. In one embodiment the precursor gas 190C is ammonia. In one embodiment, where the precursor gas 190C is utilized, the precursor gas includes boron. In one embodiment the precursor gas 190C is boron trichloride. In one embodiment, where the precursor gas 190C is utilized, the precursor gas includes oxygen and/or ozone.

In one embodiment, the part 50 is a functionally graded structure. For example, the part 50 is printed to vary a relative volume fraction of the fiber and the ceramic. Alternatively, or in addition, the part 50 is printed to vary the relative amount silicon, hafnium, zirconium, titanium, tantalum, tungsten, tungsten, niobium, molybdenum, or rhenium. Alternatively, or in addition, the part 50 is printed to vary a relative amount of boron, carbon, nitrogen, and oxygen.

Functionally Graded Materials (FGMs) are a class of materials characterized by a gradual change in composition, microstructure, or both, across their dimensions. This allows for tailoring specific properties, like thermal resistance or mechanical strength, by smoothly transitioning between different materials or microstructures. The embodiments also cover distinct, abrupt, stepped, discrete, and periodic and random changes in composition of any of the precursors 190 and fiber feedstocks 200 utilized in building up the part 50, including but not limited varying the relative amounts silicon, hafnium, zirconium, titanium, tantalum, tungsten, tungsten, niobium, molybdenum, or rhenium. As indicated, alternatively, or in addition, the part 50 is printed to vary a relative amount of boron, carbon, nitrogen, and oxygen.

That is, the robot 140 may apply any one of the available precursors 190 and fiber feedstocks 200 as instructed and/or programmed when building up the part 50, either functionally graded (i.e., gradually) or graded otherwise (for simplicity, functional grading and other grading may be generally referred to as grading, i.e., providing a graded structure). The grading may occur over small or large fractions of layer 55 or may occur between layers rather than within a single layer, during build-up. Alternatively, it is to be appreciated that each layer 55, as well as a plurality of the layers 55, or the entirety of the part 50, may be formed with a uniform (i.e., the same, unchanging) composition of one or more precursors 190 and/or fiber feedstock 200. That is, the ceramic matrix composite 50A may be formed of the same material throughout the part 50 (or one or more layers 55), and/or the fiber feedstock 200 may be formed of the same material throughout the part 50 (or one or more layers 55).

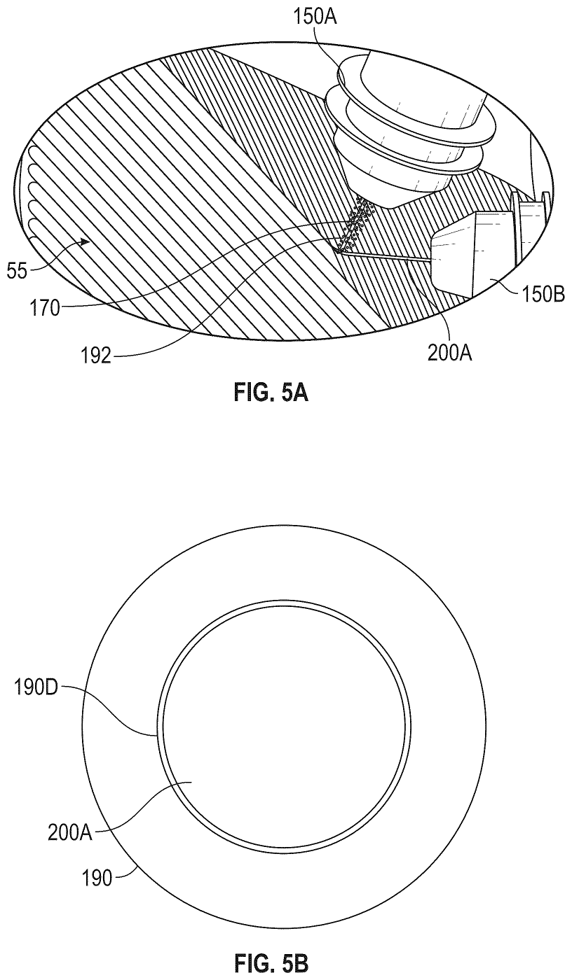

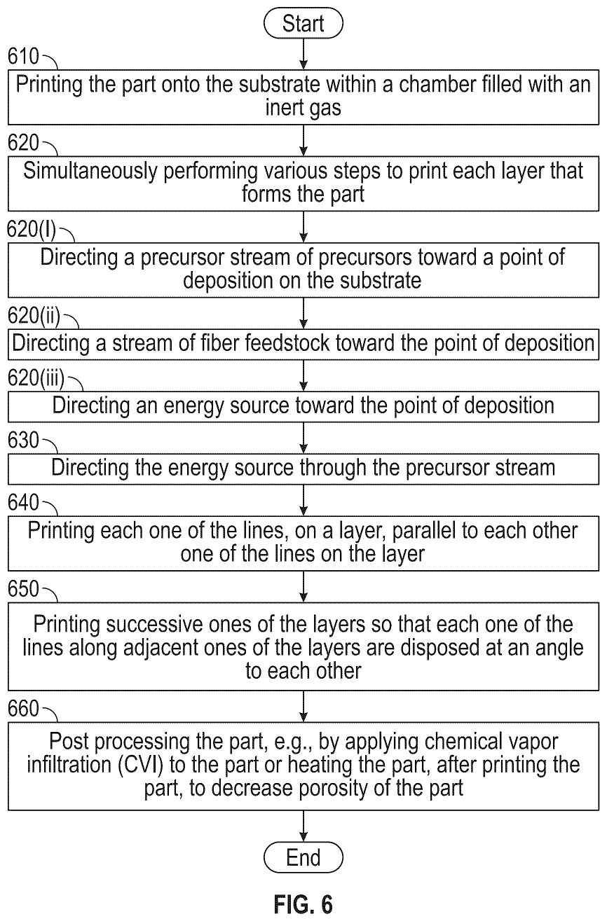

In one example, shown schematically in FIG. 5B there may be an interface layer 190D surrounding at least a portion of the fiber feedstock 200 (i.e., formed by interacting with the fiber feedstock stream 200A) and thus be located between the fiber feedstock 200 and the ceramic formed by another one or more selected precursors 190. Such interface layer 190D may also be a ceramic and be much thinner than the ceramic layer. The interface layer 190D may, long term, promote debonding of the connection between the fiber feedstock 200 and ceramic matrix composite 50A. In addition, or alternatively, the interface layer 190D may protect the fiber feedstock 200 from oxidation, structural compromise, reactions between the fiber feedstock 200 and the ceramic layer 50C, as non-limiting examples.

For example, should a layer crack under or otherwise structurally fail on part, an interface layer 190D may prevent the crack or structural failure from propagating throughout the structure, as would be appreciated by one skilled in the art when designing ceramic composite parts. In other words, when building up the part 50, in addition to the robot 140 applying precursors 190 to build-up a ceramic around the fiber feedstock 200, the robot 140 may be programed to select one of the precursors 190 to provide the interface layer 190D, such that one or more of the precursors 190 forms an interface between the fiber feedstock 200 and another one or more of the precursors 190.

The first precursor 190A may be directed to the substrate 130 as a precursor stream 192, which may also be considered a first precursor stream 192A, through the first nozzle 150A. The fiber feedstock 200 may be directed to the substrate 130 as a fiber feedstock stream 200A of the fiber feedstock 200.

The part 50, as indicated, may be manufactured by the system 100 as a ceramic matrix composite 50A having a base 50B with a ceramic 50C surrounding the fiber 50F (FIG. 1B). The type of ceramic 50C would depend on the utilized precursors 190. As a nonlimiting example, if silicon and a carbon coating or a methane gas environment is utilized as one of the precursors (or the only precursor) 190, then the ceramic 50C would be formed of silicon carbide. As another nonlimiting example, if hafnium is utilized as one of the precursors (or the only precursor) 190, then the ceramic 50C would be hafnium carbide.

In one embodiment, there may be a plurality of precursor storage units 180) for the precursors 190 (i.e., a plurality of precursors) and a plurality of feedstock storage units 185 for the fiber feedstock 200. The precursors 190 may be configured differently in each of the precursor storage units 180. For avoidance of doubt, the system is not limited to two storage units for either of the precursor 180 or the fiber feedstock 185.

For example, in a first precursor storage unit 180A of the precursor storage units 180, storing the first precursor 190A, the first precursor 190A may be the first material and more specifically silicon (as a nonlimiting example) and a second precursor 190B, which may be for example, as indicated, a precursor coating 190B may be formed of the second material and more specifically of carbon, e.g., where the ceramic is silicon carbide. In the second one of the precursor storage units 180B for the precursors 190, the first precursor 190A may be formed of the first material and more specifically hafnium (as a nonlimiting example) and the precursor coating 190B may be formed of the second material and more specifically of boron, so that the ceramic is hafnium diboride (HfB₂).

It is within the scope of the embodiments to change the first material and not the second (or vice versa) so that, e.g., the change in the ceramic matrix composite 50A can be silicon carbide to hafnium carbide. In one embodiment, the precursors 190 in either or both of the precursor storage units 180 may be formed of the second material and the precursor coating 190B may be formed of the first material. There may be more storage units having further permutations and arrangements of the first and second materials. Each of the precursors 190A-190C may be utilized by the system in a respective plurality of precursor streams, i.e., a first precursor stream 192A, a second precursor stream 192B, and a third precursor stream 192C (generally referenced, as indicated, as 192).

In an embodiment where the precursor gas 190C, i.e., the third precursor, is utilized and the first precursor 190A, i.e., the first material, in a first precursor storage unit 185A of the precursor storage units 180 for the precursors 190, and the first precursor 190A may be silicon (as a nonlimiting example). In such embodiment, in a second one of the precursor storage units 180 for the precursors 190, the precursor therein may be titanium (as a nonlimiting example).

Similarly, in a first one of the feedstock storage units 185A for the fiber feedstock 200, the fiber feedstock 200 may be one of continuous 50D or discontinuous fibers 50E. In the second feedstock storage unit 185B of the feedstock storage units 185 for the fiber feedstock 200, the fiber feedstock 200 may be another of continuous 50D or discontinuous fibers 50E.

A controller 146 of the robot 140 may select between the different ones of the precursor storage units 180 for the precursors 190 and between the different ones of the feedstock storage units 185 for the fiber feedstock 200. This selection may occur while the part 50 is being built up, to provide the graded structure as indicated above. It can be appreciated that the different layers 55A, 55B and lines 60A, 60B may be formed to have different characteristics from each other to provide the desired part characteristics.

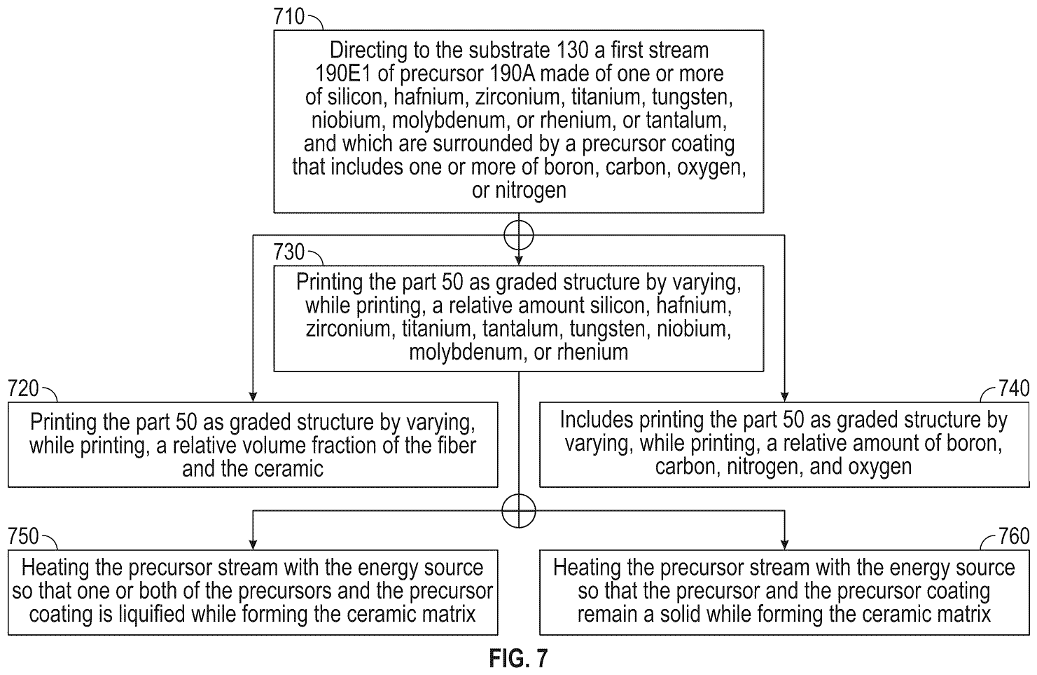

Turning to FIG. 6, a flowchart shows a method of additively manufacturing the part 50, line-by-line, and layer-by-layer, on the substrate 130 utilizing the system 100, according to an embodiment.

As shown in block 610, the method includes printing the part 50 onto the substrate 130 within a chamber 110 filled with an inert gas 120. As shown in block 620 the method includes simultaneously performing various steps to print each line of each layer that forms the part 50, utilizing the system 100. As shown in block 620 (i), a first step includes directing a fiber feedstock stream 200A of fiber feedstock 200 toward the point of deposition via the second nozzle 150B. As shown in block 620 (ii), a second step includes directing a precursor stream 192 of one or more precursors 190 toward a point of deposition on the substrate 130, e.g., via the first nozzle 150A, onto at least one of the substrate 130 or the fiber feedstock 200. As shown in block 620 (iii), a third step includes directing an energy source 170 (otherwise referred to as an energy stream) toward the point of deposition.

As indicated above, the one or more precursors 190 may be formed of the first material. The one or more precursors 190 may be surrounded by the second precursor 190B and/or may engage a precursor gas 190C at the point of deposition on the substrate 130, where the precursor gas 190C is made of the third material, discussed above. From this action, the ceramic matrix composite 50A is formed at the point of deposition and includes a ceramic 50C embedded with fibers 50F from the fiber feedstock 200. The ceramic 50C is formed from the combination of the precursors 190 combined with the precursor coating 190B or the precursor gas 190C. Steps shown in blocks 620(i)-620(iii) are repeated until printing the layer 55 is complete. As shown in block 630 the method includes directing the energy source 170 through one or more of the precursor stream 192 or the fiber feedstock stream 200A.

As shown in block 640, when printing the part 50, the method includes printing each one of the lines 60, on a layer 55, parallel to each other one of the lines 60 on the layer 55. As shown in block 650 the method includes printing successive ones of the layers 55 so that each one of the lines 60 along adjacent ones of the layers 55 are disposed at an angle to each other. This is optional and may provide a desired strength characteristic to the part 50. As shown in block 660, the method includes, after printing the part 50, post processing the part 50, e.g., by one or more of applying chemical vapor infiltration (CVI) to the part 50 to decrease porosity of the part 50, or heating the part 50, to further complete conversion of precursor to product and/or densify the part 50 by sintering.

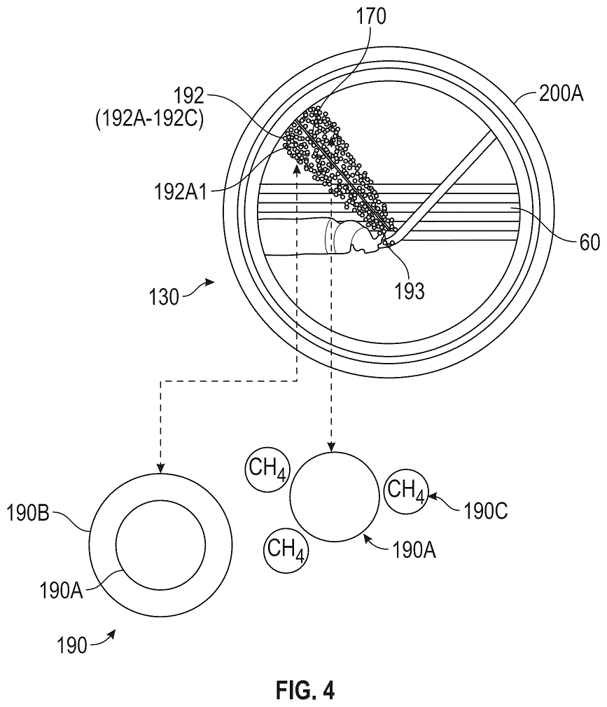

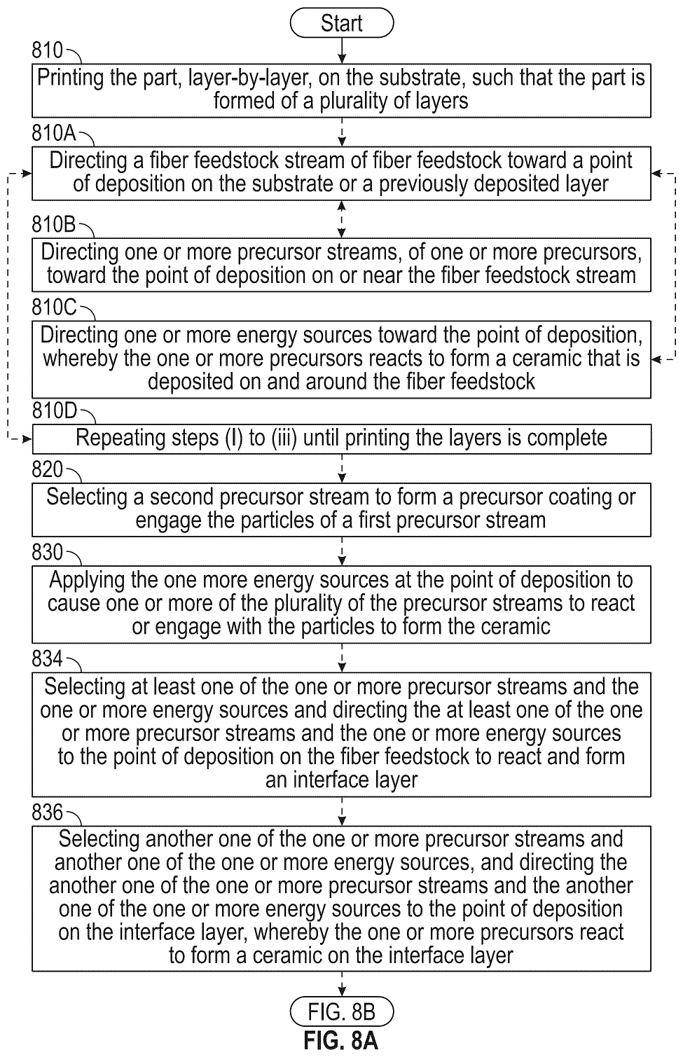

Turning to FIG. 7, additional details regarding printing of the part 50 are disclosed. In one embodiment, deposition of the precursor stream 192 includes, as shown in block 710, directing to the substrate 130, one or more precursors 190, i.e., at least two precursors 190, and in some embodiments, at least three precursors 190 (FIG. 4), respectively made of one or more materials, e.g., silicon, hafnium, zirconium, titanium, tantalum, tungsten, niobium, molybdenum, or rhenium, and which are surrounded by a precursor coating 190B that includes one or more of boron, carbon, oxygen, or nitrogen. That is, the precursors 190 may be mutually unique materials configured to react with one another to thereby form the ceramic 50C. The precursors 190 may be the same phase as each other or different phases from each other, such as a liquid and a gas, to react against the fiber feedstock stream 200A.

As shown in block 720, the method includes printing the part 50 as graded structure by varying, while printing, a relative volume fraction of the fiber feedstock 200 and the ceramic 50C. In addition or alternatively, as shown in block 730, the method includes printing the part 50 as graded structure by varying, while printing, a relative amount silicon, hafnium, zirconium, titanium, tantalum, tungsten, niobium, molybdenum, or rhenium. In addition, or alternatively, as shown in block 740, the method includes printing the part 50 as graded structure by varying, while printing, a relative amount of boron, carbon, nitrogen, and oxygen.

As shown in block 750, the method includes heating the precursor stream 192 with the energy source 170 so that one or more of the precursors 190, and/or the precursor coating 190B, is liquified while forming the ceramic 50C. This process may occur when either or both of the precursors 190, and/or the precursor coating 190B, is formed of a material with a relatively low melting temperature. Alternatively, as shown in block 760, the method includes heating the precursor stream 192 with the energy source 170 so that the precursors 190, and/or the precursor coating 190B, remain a solid while forming the ceramic 50C. This process may occur when the precursors 190, and/or the precursor coating 190B, are both formed of a material having a relatively high melting temperature.

With the disclosed embodiments, the system 100 may utilize one or more precursor streams 192, each precursor stream 192 may include one or more precursors 190. Within each precursor stream 192, there may be carriers (i.e., non-reacting fluids in the stream for conveying the precursors, utilized to regulate pressures and flow rates. The precursors 190 may be solids (particulates), liquid or gas. A first precursor 190A may be solid, and this may be coated with a second precursor 190B which may be a gas. The second precursor 190B (gas or liquid) may coat the first precursor 190A (solid) via adhesion (physically) or via reaction (chemically). One or more precursors 190 (coming from the one or more precursor streams 192) may react to form a ceramic 50C that is deposited on the substrate 130 and/or fiber feedstock 200.

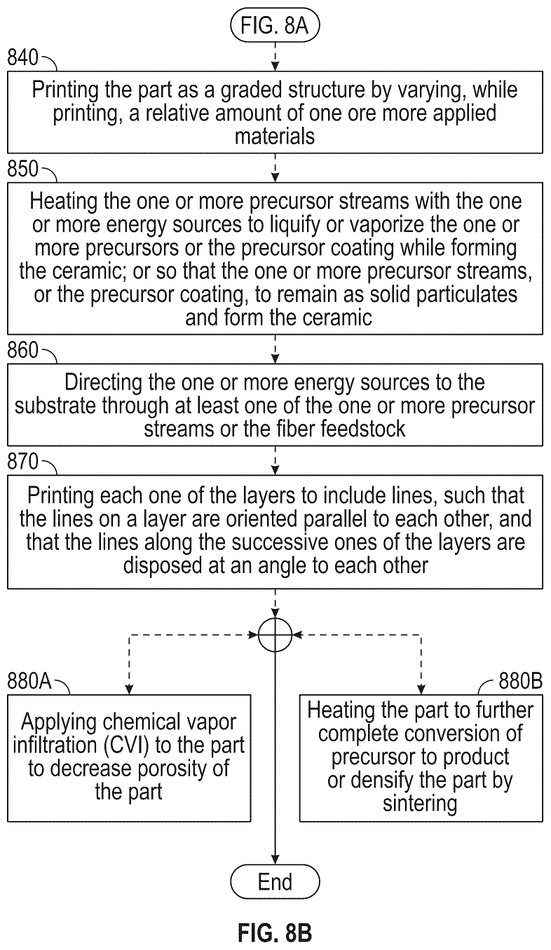

Turning to FIGS. 8A and 8B, the method of additively manufacturing the part 50 is shown according to other aspects of the embodiments. It is to be appreciated that a part 50 additively manufacturing according to the disclosed method is within the scope of the disclosure. Boxes in dashed lines in the flowchart represent further explanations, including alternative embodiments, of one or more preceding steps and are not intended to limit the scope of the embodiments.

As shown in block 810, the method includes printing the part 50, layer-by-layer, on the substrate 130, such that the part 50 is formed of a plurality of layers 55. As shown in blocks 81A-810C, each of the layers 55 is built up by simultaneously performing different steps.

As shown in block 810A, a first step (i) is directing a fiber feedstock stream 200A of fiber feedstock 200 toward a point of deposition on the substrate 130, or a previously deposited layer. As shown in block 810B, a second step (ii) is directing one or more precursor streams 192, of one or more precursors 190, toward the point of deposition on or near the fiber feedstock stream 200A. As shown in block 810C, a third step (iii) is directing one or more energy sources 170 toward the point of deposition. From this action, the one or more precursors 190 reacts to form a ceramic 50C that is deposited on and around the fiber feedstock 200. That is, from these steps, a ceramic matrix composite 50A is formed (e.g., the combination of the ceramic 50C formed by the precursors 190 and the fiber feedstock 200 in the fiber feedstock stream 200A) that includes a ceramic 50C embedded with fibers 50F from the fiber feedstock 200. As shown in block 810D, the method includes repeating steps (i) to (iii) until printing the layers 55 is complete.

As indicated, the one or more precursor streams 192 may include a plurality of precursor streams 192. The plurality of precursor streams 192 may be formed of mutually unique materials configured to react with one another to thereby form the ceramic 50C. The plurality of precursor streams 192 may include a first precursor stream 192A and a second precursor stream 192B. The first precursor stream 192A may include particles 192A1.

As shown in block 820, the method includes selecting the precursors 190, such as first and second precursors 190A, 190B, and applying the one or more energy sources 170 to form the precursor coating 190B or engage particles 192A1 in the first precursor stream 192A. As shown in block 830, the method includes applying the one or more energy sources 170 at the point of deposition 193 to cause one or more of the plurality of precursor streams 192 to react or engage with the particles 192A1 to form the ceramic 50C.

As shown in block 834, the method includes selecting at least one of the one or more precursor streams 192 and the one or more energy sources 170 and directing the at least one of the one or more precursor streams 192 and the one or more energy sources 170 to the point of deposition 193 on the fiber feedstock 200 to react and form the interface layer 190D. As shown in block 836, the method includes selecting another one of the one or more precursor streams 192 and another one of the one or more energy sources 170 and directing the another one of the one or more precursor streams 192 and the another one of the one or more energy sources 170 to the point of deposition 193 on the interface layer 190D. From this configuration, the one or more precursors 190 react to form the ceramic 50C on the interface layer 190D.

As shown in block 840, the method includes printing the part 50 as a graded structure by varying, while printing, a relative amount of one or more applied materials. The applied materials include, as indicated, one or more of silicon, hafnium, zirconium, titanium, tantalum, tungsten, niobium, molybdenum, rhenium, boron, carbon, nitrogen, or oxygen. As shown in block 850, the method includes heating the one or more precursor streams 192 with the one or more energy sources 170 to liquify or vaporize the one or more precursors 190 and/or the precursor coating 19B while forming the ceramic 50C. Alternatively, the heating causes one or more precursor streams 192, and/or the precursor coating 190B, to remain as solid particulates and form the ceramic 50C. As shown in block 860, the method includes directing the one or more energy sources 170 to the substrate 130 through at least one of the one or more precursor streams 192 or the fiber feedstock 200. As shown in block 870, the method includes printing each one of the layers 55 to include lines 60, such that the lines 60 on a layer 55 are oriented parallel to each other, and the lines 60 along successive ones of the layers 55 are disposed at an angle to each other.

As shown in block 880A, the method includes, after printing the part 50, applying chemical vapor infiltration (CVI) to the part 50 to decrease porosity of the part. In addition to block 880A, or alternatively, as shown in block 880B, the method includes heating the part 50 to further complete conversion of precursors 190 to product and/or densify the part 50 by sintering.

Thus, according to the embodiments, a feedstock of continuous or discontinuous fiber is robotically (or otherwise automatically) placed while co-extruding or spraying a matrix material such as silicon, hafnium, zirconium, titanium, or tantalum, tungsten, niobium, molybdenum, or rhenium, and/or their oxides. Simultaneously, a laser or arc energy source is directed at the point of deposition to heat and convert the materials to a ceramic. This process occurs in a reactive gas-atmosphere such as methane, ammonia, or other gas conducive to the reaction. This in-situ reaction process results in pyrolysis and densification in one step and creates a net-shape finished part. The feedstock material is formed of continuous or discontinuous fiber as well as metallic precursor reactants with or without the addition of their counterpart oxides. The fiber may be carbon fiber, silicon carbide fiber, or other ceramic fiber(s).

Benefits of the embodiments include a reduced time for post processing. The disclosed process enables the fabrication of relatively complex geometries having internal features. The process also utilizes a relatively small fraction of the energy required by typical methods.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of additively manufacturing a part, comprising:
printing the part, layer-by-layer, on a substrate, such that the part is formed of a plurality of layers,
wherein each of the layers is built up by simultaneously:
(i) directing a fiber feedstock stream, of fiber feedstock, toward a point of deposition on the substrate or a previously deposited layer;
(ii) directing one or more precursor streams, of one or more precursors, toward the point of deposition on or near the fiber feedstock stream; and
(iii) directing one or more energy sources toward the point of deposition, whereby the one or more precursors reacts to form a ceramic that is deposited on and around the fiber feedstock,
thereby forming a ceramic matrix composite that includes the ceramic formed from the one or more precursor streams embedded with fiber from the fiber feedstock; and
repeating steps (i) to (iii) until printing the layers is complete.

2. The method of claim 1, wherein:
the one or more precursor streams includes a plurality of precursor streams, wherein the plurality of precursor streams are formed of mutually unique materials configured to react with one another to thereby form the ceramic.

3. The method of claim 2, wherein
the plurality of precursor streams includes a first precursor stream and a second precursor stream,
wherein the first precursor stream comprises particles, and
the method includes:
selecting the second precursor stream to form a precursor coating or engage the particles in the first precursor stream, and
applying the one or more energy sources at the point of deposition to cause one or more of the plurality of precursor streams to react or engage with the particles to form the ceramic.

4. The method of claim 2, wherein:
the one or more precursors includes a plurality of precursors,
wherein one of the plurality of precursors includes one or more of silicon;
hafnium; zirconium; titanium; tantalum; tungsten; niobium; molybdenum; or rhenium; and
another one of the plurality of precursors includes one or more of boron, carbon, oxygen, or nitrogen;
or
a combination of any one of the plurality of precursors, within and between layers.

5. The method of claim 1, further comprising
selecting at least one of the one or more precursor streams and the one or more energy sources and directing the at least one of the one or more precursor streams and the one or more energy sources to the point of deposition on the fiber feedstock to react and form an interface layer; and
selecting another one of the one or more precursor streams and another one of the one or more energy sources, and directing the another one of the one or more precursor streams and the another one of the one or more energy sources to the point of deposition on the interface layer, whereby the one or more precursors react to form the ceramic on the interface layer;
thereby forming the ceramic matrix composite comprising the fiber feedstock, the ceramic, and the interface layer between the fiber and the ceramic.

6. The method of claim 1, wherein:
the fiber comprises one or more of a ceramic fiber, a carbon fiber or silicon carbide fiber; and
the ceramic comprises of one or more of a carbon, boron carbide, boron nitride, silicon carbide, silicon nitride, hafnium carbide, or zirconium carbide.

7. The method of claim 5, wherein the interface layer comprises one or more of a carbon, or boron nitride.

8. The method of claim 1, comprising printing the part as a graded structure by varying, while printing, a relative amount of one or more of silicon, hafnium, zirconium, titanium, tantalum, tungsten, niobium, molybdenum, rhenium, boron, carbon, nitrogen, or oxygen.

9. The method of claim 3, comprising
heating the one or more precursor streams with the one or more energy sources to liquify or vaporize the one or more precursors or the precursor coating while forming the ceramic; or so that the one or more precursor streams, or the precursor coating, to remain as solid particulates and form the ceramic.

10. The method of claim 1, comprising
directing the one or more energy sources to the substrate through at least one of the one or more precursor streams or the fiber feedstock.

11. The method of claim 1, comprising:
printing each one of the layers to comprise lines, wherein:
the lines on a layer are oriented parallel to each other; and
the lines along successive ones of the layers are disposed at an angle to each other.

12. The method of claim 1, further including, after printing the part, one or more of:
applying chemical vapor infiltration (CVI) to the part to decrease porosity of the part; or
heating the part to further complete conversion of precursors to product or densify the part by sintering.

13. A system for additively manufacturing a part, comprising:
a chamber that is filled with an inert gas;
a substrate in the chamber;
a robotic arm in the chamber, wherein the robotic arm has one or more nozzles, and wherein the robotic arm is configured to produce an energy source;
one or more precursor storage units from which the one or more nozzles obtains one or more precursors; and
one or more feedstock storage units from which the one or more nozzles obtains fiber feedstock;
wherein the robotic arm is configured to print the part, layer-by-layer, on the substrate, such that the part is formed of a plurality of layers,
and
wherein, within each one of the plurality of layers, the robotic arm is configured to, simultaneously:
(i) direct a fiber feedstock stream, of the fiber feedstock, toward a point of deposition on the substrate or a previously deposited layer;
(ii) direct one or more precursor streams toward the point of deposition on or near the fiber feedstock stream, and at least one of the one or more precursor streams includes a first precursor; and
(iii) direct one or more energy sources toward the point of deposition, whereby the one or more precursors reacts to form a ceramic that is deposited on and around the fiber feedstock,
thereby forming a ceramic matrix composite that includes the ceramic formed from the one or more precursor streams embedded with fiber from the fiber feedstock; and
repeating steps (i) to (iii) until printing the layers is complete.

14. The system of claim 13, wherein:
the one or more precursor streams includes a plurality of precursor streams, wherein the plurality of precursor streams are formed of mutually unique materials configured to react with one another to thereby form the ceramic.

15. The system of claim 13, wherein
at least one of the one or more precursor streams, and the one or more energy sources, are configured for being selected, and the at least one of the one or more precursor streams and the one or more energy sources are configured for being directed to the point of deposition on the fiber feedstock to react and form an interface layer;
another one of the one or more precursor streams and another one of the one or more energy sources are configured for being selected, and directing the another one of the one or more precursor streams and the another one of the one or more energy sources are configured for directed to the point of deposition on the interface layer, whereby the one or more precursors react to form the ceramic on the interface layer;
whereby the ceramic matrix composite is formed, comprising the fiber feedstock, the ceramic, and the interface layer between the fiber and the ceramic.

16. The system of claim 13, wherein:
the one or more precursor streams is configured for being selected and the one or more energy sources is configured for being applied so that one of the one or more precursor streams is configured to form a precursor coating; and
the one or more precursor streams is configured for being heated with the one or more energy sources:
to liquify or vaporize the one or more precursors or the precursor coating while forming the ceramic; or
so that the one or more precursor streams, or the precursor coating, remain solid particulates and form the ceramic.

17. An additively manufactured part, produced by a method comprising:
printing the part, layer-by-layer, on a substrate, such that the part is formed of a plurality of layers,
wherein, each one of the layers is printed by simultaneously:
(i) directing a fiber feedstock stream, of fiber feedstock, toward a point of deposition on the substrate or a previously deposited layer;
(ii) directing one or more precursor streams, of one or more precursors, toward the point of deposition on or near the fiber feedstock stream; and
(iii) directing one or more energy sources toward the point of deposition, whereby the one or more precursors reacts to form a ceramic that is deposited on and around the fiber feedstock,
thereby forming a ceramic matrix composite that includes the ceramic formed from the one or more precursor streams embedded with fiber from the fiber feedstock; and
repeating steps (i) to (iii) until printing the one of the layers is complete.

18. The part of claim 17, wherein:
the one or more precursor streams includes a plurality of precursor streams, wherein the plurality of precursor streams is formed of mutually unique materials configured to react with one another to thereby form the ceramic.

19. The part of claim 17, wherein the method further comprises:
selecting at least one of the one or more precursor streams and the one or more energy sources and directing the at least one of the one or more precursor streams and the one or more energy sources to the point of deposition on the fiber feedstock to react and form an interface layer;
selecting another one of the one or more precursor streams and another one of the one or more energy sources, and directing the another one of the one or more precursor streams and the another one of the one or more energy sources to the point of deposition on the interface layer, whereby the one or more precursors react to form the ceramic on the interface layer;
thereby forming the ceramic matrix composite comprising the fiber feedstock, the ceramic, and the interface layer between the fiber and the ceramic.

20. The part of claim 17, wherein the method further comprises:
heating the one or more precursor streams with the one or more energy sources:
to liquify or vaporize the one or more precursors, or a precursor coating, while forming the ceramic; or so that the one or more precursor streams, or the precursor coating, remain solid particulates and form the ceramic.
